(19) United States
(12) Patent Application Publication
(10) Pub. No.: US 2022/0188031 A1
(43) Pub. Date: Jun. 16, 2022

(54) INFORMATION PROCESSING APPARATUS FOR DATA WRITING AND COMPUTER-READABLE RECORDING MEDIUM HAVING STORED THEREIN CONTROL PROGRAM

(71) Applicant: FUJITSU LIMITED, Kawasaki-shi (JP)

(72) Inventor: Shinya KUWAMURA, Kawasaki (JP)

(73) Assignee: FUJITSU LIMITED, Kawasaki-shi (JP)

(21) Appl. No.: 17/468,730

(22) Filed: Sep. 8, 2021

(30) Foreign Application Priority Data
Dec. 11, 2020 (JP) 2020-206181

(51) Int. Cl. G06F 3/06; G06F 8/41

(52) U.S. Cl. CPC G06F 3/0659; G06F 3/0653; G06F 8/41; G06F 3/0673; G06F 3/0604

(57) ABSTRACT

An apparatus includes: a memory and a processor that: obtains, when an operating system detects a first writing process writing first data into a region in a process space in which region a file stored in a storage is mapped, a first size of the first data from information recording a data size of target data for a target address for each of writing processes; reads, when the first size is less than a threshold, a second data corresponding to the first data and having a second size larger than the first size from the file stored in the storage into the memory; rewrites part of the second data stored in a writing region of the second data in the memory with the first data; and writes third data in the writing region into the file stored in the storage, the third data being a result of the rewriting.

### CROSS-REFERENCE TO RELATED APPLICATION

This application is based upon and claims the benefit of priority of the prior Japanese Patent application No. 2020-206181, filed on Dec. 11, 2020, the entire contents of which are incorporated herein by reference.

### FIELD

The embodiments discussed herein are related to an information processing apparatus for data writing and a computer-readable recording medium having stored therein a control program.

### BACKGROUND

In an information processing apparatus such as a server, a Personal Computer (PC), and a controller of a storage device, an access to a storing unit is made by an Operating System (OS) executed by a processor such as a Central Processing Unit (CPU). Examples of the storage unit are a magnetic disk device such as a Hard Disk Drive (HDD), a semiconductor memory device such as a Solid State Drive (SSD), and a non-volatile memory such as a Storage Class Memory (SCM).

For an information processing apparatus, various access schemes using a page cache of a main storing device such as a memory of a Dynamic Random Access Memory (DRAM) have been known in order to increase the performance of an access to a file in a storing unit.

One example of the schemes is accessing using a memory mapping process performed by an OS. In a memory mapping process, the OS maps (mmaps) part or entire of a writing target file into a process space used by an application which space is exemplified by a virtual address space. Hereinafter, the storing region in which a file is mapped in a virtual address space is referred to as an mmap region.
[Patent Document 1] Japanese Laid-open Patent Publication 2019-139404
[Patent Document 2] Japanese Laid-open Patent Publication 2012-038246

In accessing a storing unit, a writing performance when data is written into a storing region in which a file is mapped may sometimes lower depending on one or both of the characteristics of the access target data and the state of the data. A storing region in which a file is mapped is not limited to an mmap region used for a memory mapping process and may alternatively be various address spaces (regions) used by other schemes.

### SUMMARY

According to an aspect of the embodiments, an information processing apparatus includes: a memory; and a processor coupled to the memory, the processor being configured to: obtain, when an operating system detects a first writing process writing first data into a region in a process space in which region a file stored in a storage is mapped, a first data size of the first data from recording information recording a data size of writing target data for a target address for each of a plurality of writing processes, the first writing process being one of the plurality of writing processes that an application executes; read, when the first data size is less than a first threshold, a second data corresponding to the first data and having a second data size larger than the first data size from the file stored in the storage into the memory; and rewrite part of the second data stored in a writing region of the second data in the memory with the first data; and write third data in the writing region in the memory into the file stored in the storage, the third data being a result of rewriting the part of the second data with the first data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an mmap region in a memory mapping process;

FIG. 2 is a diagram illustrating an example operation of a data writing process into an mmap region;

FIG. 3 is a diagram illustrating an example of operation of a file writing process (writing process) by an OS;

FIG. 4 is a flow diagram illustrating an example of operation of a scheme of enhancing a writing performance into a region mapped with a file;

FIG. 5 is a diagram illustrating an example of a hardware (HW) configuration of a computer according to a first embodiment;

FIG. 6 is a block diagram illustrating an example of a functional configuration of a server according to the first embodiment;

FIG. 7 is a diagram illustrating an example of a data size recording table;

FIG. 8 is a diagram illustrating an example of operation of a writing process according to the first embodiment;

FIG. 9 is a sequence diagram illustrating an example of operation of a writing process according to the first embodiment;

FIG. 10 is a flow diagram illustrating an example of operation when the server executes compiling of the first embodiment;

FIG. 11 is a flow diagram illustrating an example of operation when the server executes a writing process of the first embodiment;

FIG. 12 is a block diagram illustrating an example of a functional configuration of a server according to a first modification to the first embodiment;

FIG. 13 is a flow diagram illustrating an example of operation when the server executes compiling of the first modification to the first embodiment;

FIG. 14 is a flow diagram illustrating an example of operation when the server executes a writing process of the first modification to the first embodiment;

FIG. 15 is a block diagram illustrating an example of a functional configuration of a server according to a second modification to the first embodiment;

FIG. 16 is a flow diagram illustrating an example of operation when the server executes an analysis process of the second modification to the first embodiment;

FIG. 17 is a diagram illustrating an example of operation of a file writing process (direct writing) by an OS;

FIG. 18 is a block diagram illustrating an example of a functional configuration of a server according to a second embodiment;

FIG. 19 is a block diagram illustrating an example of the configuration of a memory unit of the second embodiment;

FIG. 20 is a flow diagram illustrating an example of operation when the server executes a writing process of the second embodiment;

FIG. 21 is a block diagram illustrating an example of a functional configuration of a server according to a first modification to the second embodiment;

FIG. 22 is a flow diagram illustrating an example of operation when the server executes a writing process of the first modification to the second embodiment;

FIG. 23 is a block diagram illustrating an example of a functional configuration of a server according to a second modification to the second embodiment; and

FIG. 24 is a flow diagram illustrating an example of operation when the server executes a writing process of the second modification to the second embodiment.

### DESCRIPTION OF EMBODIMENT(S)

Hereinafter, an embodiments of the present invention will now be described with reference to the accompanying drawings. However, the embodiments described below are merely illustrative and there is no intention to exclude the application of various modifications and techniques that are not explicitly described below. For example, the present embodiments can be variously modified and implemented without departing from the scope thereof. In the drawings to be used in the following description, like reference numbers denote the same or similar parts, unless otherwise specified.

### [1] First Embodiment

### [1-1] Description of First Embodiment

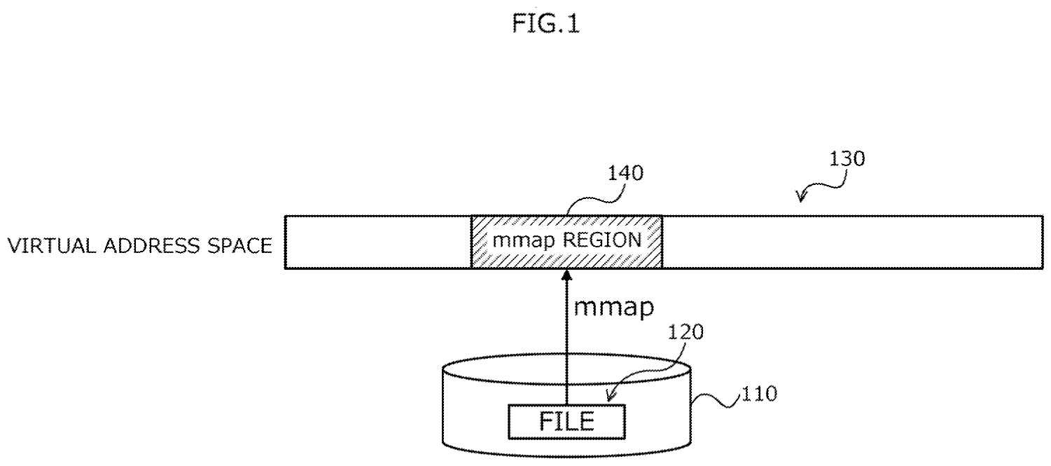

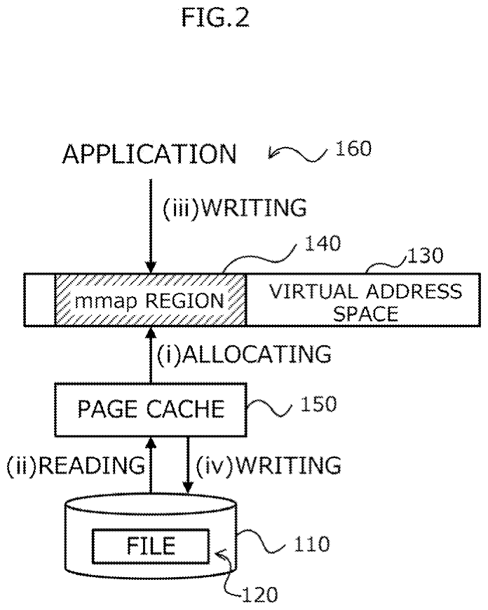

FIG. 1 is a diagram illustrating an example of an mmap region 140 in a memory mapping process, and FIG. 2 is a diagram illustrating an example of operation of a data writing process into the mmap region 140.

As illustrated in FIG. 1, in a memory mapping process, the OS maps part or entire of a file 120 that the storing unit 110 stores into a process space that an application uses, e.g., a region (an mmap region 140) of a virtual address space 130.

As illustrated in FIG. 2, in a data writing process into the mmap region 140, in cases where the data of a file 120 mapped in the mmap region 140 is not present in the page cache 150, the following processes (i) to (iv) are performed. In cases where the data is present in the page cache 150, the processes (i) and (ii) are skipped.

(i) The OS allocates one page (referred to as a “page cache”) of the memory to the virtual address space 130.

(ii) The OS reads data from the file 120 of the storing unit 110 into a page cache 150.

(iii) An application 160 writes writing target data into the page cache 150 according to a store-instruction.

(iv) The OS writes the data in the page cache 150 into the file 120 in the storing unit 110.

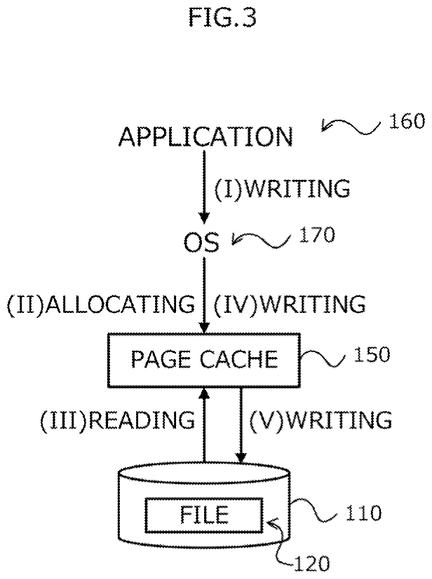

FIG. 3 is a diagram illustrating an example of operation of a file writing process (writing process) of an OS 170. As illustrated in FIG. 3, the file writing process is another example of the access scheme using the page cache 150. As illustrated in FIG. 3, in the file writing process, the following processes (I) to (V) are performed.

(I) An application 160 issues a write system call.

(II) In cases where the writing target data is not present in the page cache 150, the OS 170 allocates page cache 150 to the writing target data (i.e., file 120).

(III) In cases where the data has a data size less than the page size, the OS 170 reads the data (e.g., data having a size of a page) of the file 120 of the storing unit 110 into the page cache 150.

(IV) The OS 170 writes the writing target data into the page cache 150. For example, in cases where the data of the file 120 is read in the page cache 150 in the above process (III), the OS 170 rewrites part of data of the file 120 read into the page cache 150 with the writing target data.

(V) The data as much as a page size that the OS 170 writes into the page cache 150 is written into the file 120 of the storing unit 110. For example, in cases where the data of the file 120 is read into the page cache 150 in the above process (III), the OS 170 writes the data partially rewritten in the above process (IV) into the file 120 of the storing unit 110.

In a writing process performed by using the mmap region 140 illustrated in FIGS. 1 and 2, the OS can access the file 120 according to a load-and-store-instruction of a processor such as a CPU in the same manner as memory access.

Here, in cases where data having a size less than a given size are continuously written in each writing process illustrated in FIGS. 2 and 3, the writing process to an mmap region 140 illustrated in FIG. 2 results in higher writing performance, for example. The given size may be, for example, a page size. The page size is a size set according to (depending on, for example) the CPU and the OS 170, and is, for example, 4 KB (kilobytes) in an x86 CPU.

For example, when data of the same file 120 less than the page size (4 KB) are continuously written, each writing in the writing process illustrated in FIG. 3 generates overheads in the system call and in the process of the OS 170. In contrast to the above, when the data are continuously written into the mmap region 140, the second and subsequent writing can be accomplished only by writing according to the store-instruction because the data is present in the page cache 150.

On the other hand, in cases where data having a size equal to or more than the given size are written in each writing process illustrated in FIGS. 2 and 3, the writing process illustrated in FIG. 3 results in higher writing performance, for example.

For example, in cases where data larger than the page size (4 KB) is written into the mmap region 140 according to the example of FIG. 2, a process to read data from the file 120 of the storing unit 110 to the page cache 150 occurs before the writing, which process comes to be overhead. On the other hand, in a writing process illustrated in FIG. 3, since the data is equal to or larger than the page size, the above-described process (III) is skipped and the entire page cache 150 is rewritten with the writing target data having the page size in the above-described process (IV). In other words, this writing process can eliminate the requirement for reading data from the file 120 of the storing unit 110 in the process (III). Incidentally, the partial data less than the page size, which is the remainder when the writing target data that is equal to or larger than the page size is divided by the page size, is excluded from the comparison between the example of FIG. 2 and the example of FIG. 3. This is because, for such partial data, in both of the writing process illustrated in FIG. 2 and the writing process illustrated in FIG. 3, data as much as the page size corresponding to the partial data is read from the storing unit 110 to the page cache 150 (see the above processes (II) and (III)).

As described above, writing into the mmap region 140 is frequently performed according to a store-instruction, but the writing scheme according to the store-instruction is not the fastest in some cases which are exemplified by writing of data having a given size or more and the absence of the data in the page cache. Accordingly, the writing performance at which the application 160 writes data into the region mapped with the file 120 may decrease.

As a solution to the above, the following scheme is conceived for enhancing the accessibility to the region mapped with the file 120 (i.e., to increase the writing performance), for example.

As an example, the application 160 may invoke the memory writing Application Programming Interface (API) of the OS 170 and the OS 170 may responsively select an appropriate writing scheme in accordance with one or both of the characteristic and the state of the data and write the data in the selected writing scheme. An example of the memory writing API is memcpy of the C standard library.

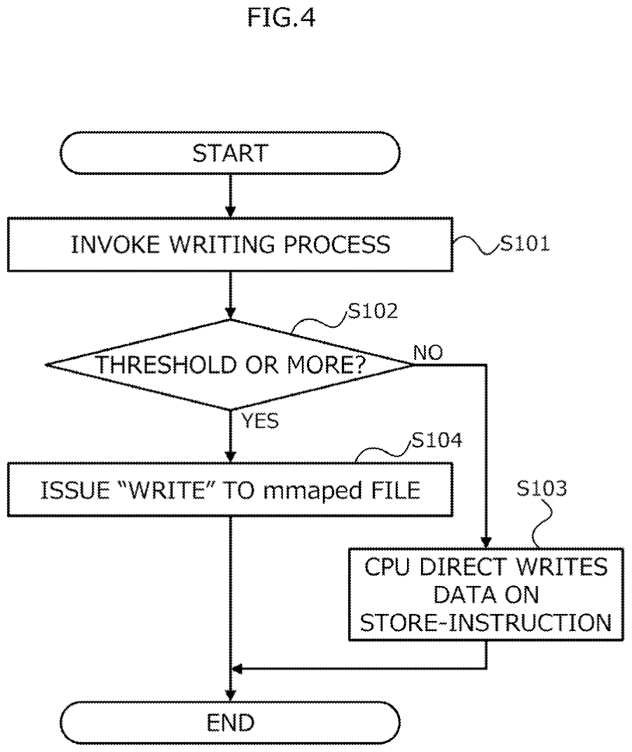

FIG. 4 is a flow diagram illustrating an example of operation of a scheme of enhancing a writing performance into a region mapped with a file 120. As illustrated in FIG. 4, the application 160 reads a writing process (memory writing API) of the OS 170 (Step S101). The OS 170 determines whether or not the data size of the writing target data is equal to or larger than a threshold (e.g., 4 KB) (Step S102). If the data size is less than the threshold (NO in Step S102), the OS 170, in other words, the CPU, writes the data directly into the mmaped file according to the store-instruction (Step S103), and the process ends. If the data size is or equal to or larger than the threshold (YES in Step S102), the OS 170 issues a “write”, which means a write system call, to the mmaped file (Step S104), and the process ends.

As the above, since the above-described scheme illustrated in FIG. 4 can select the optimum writing scheme, the writing performance into the region mapped with the file 120 can be increased.

For example, randomly writing data of 4 KB can be accomplished about ten times faster than a scheme to simply (e.g., uniformly) writing into the mmap region 140 (see FIG. 2). Even if the storing unit 110 is a high-speed non-volatile memory such as SCM, the scheme of writing into the mmap region 140 takes about 10 μs (microseconds) from invoking the writing process to the completion of the writing. The 10 μs is mainly occupied by the time for reading the data from the storing unit 110 to the page cache 150. On the other hand, in using data of 4 KB or more, i.e., data having a predetermined size or more, the above-described scheme of FIG. 4 issues a write system call directed to the mmaped file without reading the data from the storing unit 110. Although the overhead of the system call occurs, this case can reduce the time from invoking the writing process to the completion of the writing to 1 μs or less.

Thus, the scheme according to the first embodiment may employ one illustrated in FIG. 4, which also speeds up access to a storing region mapped with the file 120 of the storing unit 110.

Meanwhile, when the scheme of FIG. 4 is implemented in a computer exemplified by the OS 170 executed by a processor such as a CPU, it is conceivable to use a standard function used for writing into a memory, such as, memcpy that is one of the standard library functions of the C programming language. For example, one solution to change the call destination of the writing process on the mmap region 140 from the process using the standard function to the process of selecting the optimum writing scheme as illustrated in FIG. 4 is to rewrite the source code of an application 160.

However, the memcpy is a function used to copy (sweep) the data stored in a memory. Therefore, when the memcpy is collectively replaced for a program that achieves the process illustrated in FIG. 4, there is a possibility of causing a problem in the process by the application 160. For example, as increasing the scale of the application 160 that performs various processes, it comes more difficult to cause the computer to execute the process of FIG. 4.

With the foregoing problem in view, the first embodiment describes a scheme that increases the access performance to a storing region mapped with a file by selecting the optimum writing scheme and also that is made possible to be implemented in a computer by eliminating the requirement for rewriting of the source code of the application.

### [1-2] Example of Configuration of First Embodiment

(Example of Hardware Configuration)

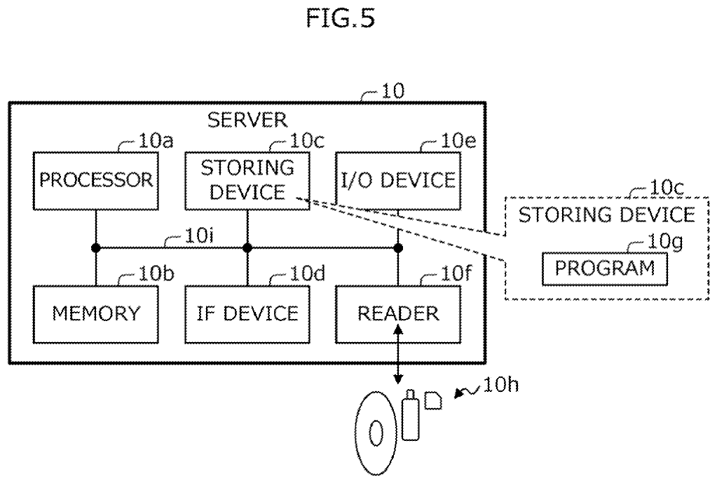

FIG. 5 is a diagram illustrating an example of a hardware (HW) configuration of a computer 10 according to a first embodiment. The computer 10 is an example of an information processing apparatus such as a server, a PC, and a controller of a storage device, and a mainframe. As illustrated in FIG. 5, the computer 10 may exemplarily include a processor 10a, a memory 10b, a storing device 10c, an IF (Interface) device 10d, an I/O (Input/Output) device 10e, and a reader 10f as the HW configuration.

The processor 10a is an example of an arithmetic processing apparatus that performs various controls and arithmetic operations. The processor 10a may be communicably connected to the blocks in the computer 10 to each other via a bus 101. In the first embodiment, the processor 10a may be a multiprocessor including multiple processors (e.g. multiple CPUs). Each of the multiple processors may be a multi-core processor including multiple processor cores.

An example of the processor 10a is an Integrated Circuit (IC) such as a Central Processing Unit (CPU), a Micro Processing Unit (MPU), a Graphics Processing Unit (GPU), an Accelerated Processing Unit (APU), a Digital Signal Processor (DSP), an Application Specific IC (ASIC), and a Field-Programmable Gate Array (FPGA). Alternatively, the processor 10a may be a combination of two or more ICs exemplified as the above.

The memory 10b is an example of a HW device that stores information such as various data pieces and a program. An example of the memory 10b includes one or both of a volatile memory such as the Dynamic Random-Access Memory (DRAM) and a non-volatile memory such as the Persistent Memory (PM).

The storing device 10c is an example of a HW device that stores information such as various data pieces and programs. Examples of the storing device 10c is various storing devices exemplified by a magnetic disk device such as a Hard Disk Drive (HDD), a semiconductor drive device such as a Solid State Drive (SSD), and a non-volatile memory. Examples of a non-volatile memory are a flash memory, a Storage Class Memory (SCM), and a Read Only Memory (ROM).

The storing device 10c may store a program log (control program) that achieves all or part of the functions of the computer 10. For example, the processor 10a expands the program log stored in the storing device 10c onto the memory 10b and executes the expanded program 10g, so that the function as the computer 10 of the first embodiment can be achieved.

The IF device 10d is an example of a communication IF that controls connection to and communication with a network between the computer 10 and another apparatus. For example, the IF device 10d may include an adaptor compatible with a Local Area Network (LAN) such as Ethernet (registered trademark) and an optical communication such as Fibre Channel (FC). The adaptor may be compatible with one of or both of wired and wireless communication schemes. For example, the program log may be downloaded from a network to a computer 10 through the communication IF and then stored into the storing device 10c.

The I/O device 10e may include one of or both of an input device and an output device. Examples of the input device are a keyboard, a mouse, and a touch screen. Examples of the output device are a monitor, a projector, and a printer.

The reader 10f is an example of a reader that reads information of data and programs recorded on a recording medium 10h. The reader 10f may include a connecting terminal or a device to which the recording medium 10h can be connected or inserted. Examples of the reader 10f include an adapter conforming to, for example, Universal Serial Bus (USB), a drive apparatus that accesses a recording disk, and a card reader that accesses a flash memory such as an SD card. The program log may be stored in the recording medium 10h. The reader 10f may read the program 10g from the recording medium 10h and store the read program log into the storing device loc.

An example of the recording medium 10h is a non-transitory computer-readable recording medium such as a magnetic/optical disk, and a flash memory. Examples of the magnetic/optical disk include a flexible disk, a Compact Disc (CD), a Digital Versatile Disc (DVD), a Blu-ray disk, and a Holographic Versatile Disc (HVD). Examples of the flash memory include a semiconductor memory such as a USB memory and an SD card.

The HW configuration of the computer 10 described above is merely illustrative. Accordingly, the computer 10 may appropriately undergo increase or decrease of HW (e.g., addition or deletion of arbitrary blocks), division, integration in an arbitrary combination, and addition or deletion of the bus. For example, at least one of the I/O device 10e and the reader 10f may be omitted in the computer 10.

(Example of Functional Configuration)

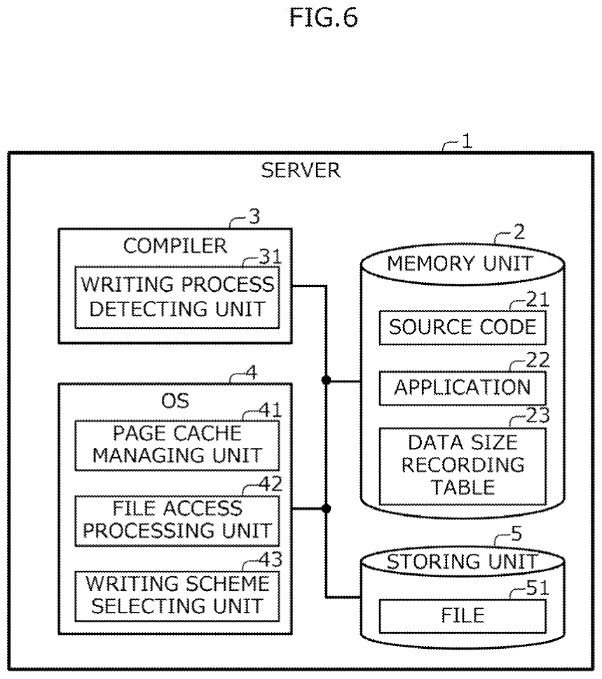

FIG. 6 is a block diagram illustrating an example of a functional configuration of a server 1 according to the first embodiment. The server 1 according to the first embodiment is one example of various information processing apparatuses such as various servers, PCs, controllers of storage devices, and mainframes. The server 1 may be, for example, a computer that processes big data, such as a computer that provides a database appliance, a storage system, or the like.

Focusing on the function related to control according to the first embodiment, the server 1 may illustratively include the functions of a memory unit 2, a compiler 3, an OS 4, and a storing unit 5, as illustrated in FIG. 6. The functions of the compiler 3 and the OS 4 may be achieved by the processor 10a of the computer 10 illustrated in FIG. 5 executing the program 10g expanded in the memory 10b.

The memory unit 2 is an example of a storing region, and stores various types of data that the server 1 uses. The memory unit 2 may be achieved, for example, by at least part of the storing region of the memory 10b illustrated in FIG. 5. As illustrated in FIG. 6, the memory unit 2 may illustratively be capable of storing a source code 21, an application 22, and a data size recording table 23.

The storing unit 5 is an example of storage or a storing region, and stores various types of data that the server 1 uses. The storing unit 5 may be achieved, for example, by at least part of the storing region of the storing device 10c illustrated in FIG. 5. As illustrated in FIG. 6, the storing unit 5 may illustratively be capable of storing a file 51.

The compiler 3 performs compiling on the source code 21 stored in the memory unit 2. For example, the compiler 3 may store, into the memory unit 2, an application 22 obtained by compiling to convert a source code 21 to machine-language (e.g., binary-code) or the like.

Furthermore, the compiler 3 of the first embodiment may include a writing process detecting unit 31. When the compiling is executed, the writing process detecting unit 31 detects a memory writing process such as a memcpy, contained in the source code 21, and obtains the data size of the data to be written in the detected writing process. For example, the writing process detecting unit 31 may record information including the obtained data size in the data size recording table 23.

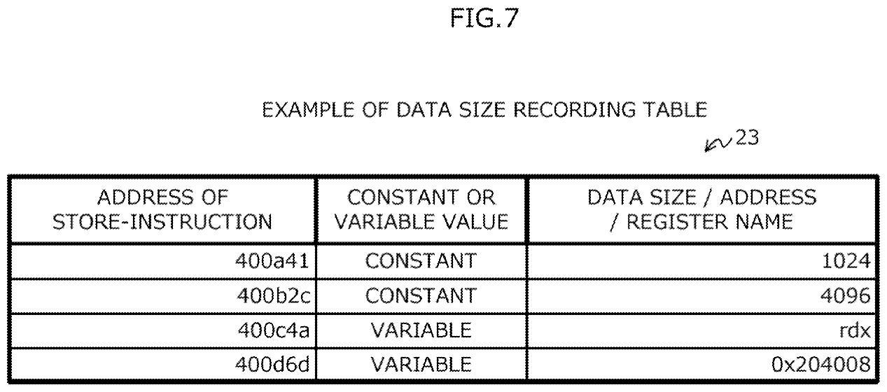

FIG. 7 is a diagram illustrating an example of the data size recording table 23. The data size recording table 23 is an example of recording information recording a data size of writing target data for a target address for each of multiple writing processes executed by the application 22. The following description assumes that the data size recording table 23 is data in table form for convenience, but the form of the data size recording table 23 is not limited to this and may alternatively be in various data forms such as a DB (Database) or arrays. As illustrated in FIG. 7, the data size recording table 23 may illustratively include items of “address of store-instruction”, “constant or variable value”, and “data size/address/register name”.

In the field of the “address of store-instruction”, a detected writing process exemplified by an address (e.g., a virtual address) of a destination of data writing according to a store-instruction directed to a file 51 mapped into the mmap region may be set.

In the field of the “constant or variable value”, information indicating whether the data size of the data related to the store-instruction is a constant value or variable value may be set.

In the field of the “data size/address/register name”, one of a “data size”, an “address” of the variable in which the data size is stored, and a “register name” of the variable may be set. For example, in cases where the data size is a “constant”, the writing process detecting unit 31 may set the “data size” of the constant into the data size recording table 23. Further, for example, in cases where the data size is a “variable”, the writing process detecting unit 31 may set the “address” or “register name” of the variable in which the data size is stored into the data size recording table 23.

In the example of FIG. 7, in the data size recording table 23, a “constant” data size “1024” is set in an entry of a store-instruction having an address “400a41”. In addition, the register name “rdx” having a stored “variable” data size is set in the entry of a store-instruction having an address “400c4a” and also the address “0x204008” having a stored “variable” data size is set in the entry of a store-instruction having an address “400d6d”.

As the above, the writing process detecting unit 31 may detect a writing process by analyzing the source code 21 carried out in the course of compiling of the source code 21 by the compiler 3 (e.g., before, after, or during the process). Then the writing process detecting unit 31 may output, as a result of the compiling, the application 22 converted from the source code 21 and the data size recording table 23 recording the obtained data size.

In other words, the writing process detecting unit 31 is an example of a generating unit that generates the recording information that associates the target address for each of the multiple writing processes contained in the source code 21 with the writing target data of the writing process on the basis of information obtained in the compiling.

The OS 4 is software that executes various processes in the server 1. For example, the OS 4 may perform, for example, memory management on the memory 10b illustrated in FIG. 5, management on the storing device 10c by the file system, and execution of the application 22.

As illustrated in FIG. 6, the OS 4 according to the first embodiment may illustratively include a page cache managing unit 41, a file access processing unit 42, and a writing scheme selecting unit 43.

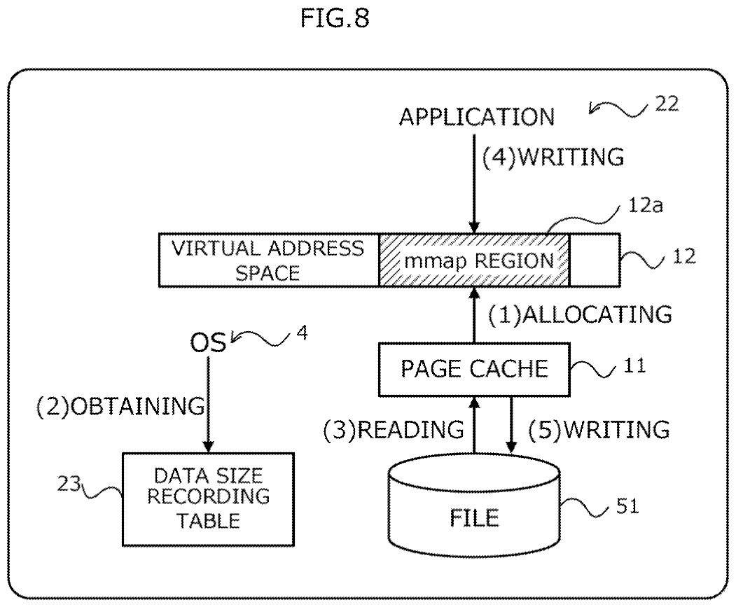

The page cache managing unit 41 manages, for example, a page cache 11 (see FIG. 8) of the memory 10b in the memory management. Although FIG. 8 illustrates, for convenience, an example that the page cache managing unit 41 managing a single page cache 11 having a page size unit, the page cache managing unit 41 may manage multiple page caches 11. Such multiple page caches 11 may be regarded as a single page cache 11 including multiple pages. The multiple page caches 11 is an example of a memory and may be implemented by at least part of the storage area that the memory 10b illustrated in FIG. 5 has. The management of the page cache 11 by the page cache managing unit 41 may include a process of allocating the page cache 11 to the virtual address space 12 (see FIG. 8), which is an example of a process space that the application 22 uses.

The file access processing unit 42 carries out, for example, in the control of the storing device 10c by the file system, a process related to an access to the file 51 stored in the storing unit 5. The file access processing unit 42 and the application 22 are an example of a reading unit, and is also an example of a writing unit.

The writing scheme selecting unit 43 is an example of an obtaining unit, and in the event of detecting a writing process into the mmap region when the OS 4 executes the application 22, obtains a data size related to the writing by referring to the data size recording table 23. Further, the writing scheme selecting unit 43 selects an optimum writing scheme based on a comparison result between the obtained data size and a threshold (first threshold) exemplified by the page size, for example, 4 KB.

The compiler 3 may be implemented in the OS 4 to serve as part of the function of OS 4. Alternatively, the compiler 3 may be provided in a computer that different from the server 1. In cases where the compiler 3 is provided in a different computer, the server 1 may further include a receiving unit that receives the application 22 and the data size recording table 23 that the compiler 3 outputs from the other computer and stores the received application and table into the memory unit 2. Also, in cases where the compiler 3 is provided in a different computer, the memory unit 2 may be allowed not to store the source code 21.

### [1-3] Description of Operation when Writing Process Occurs

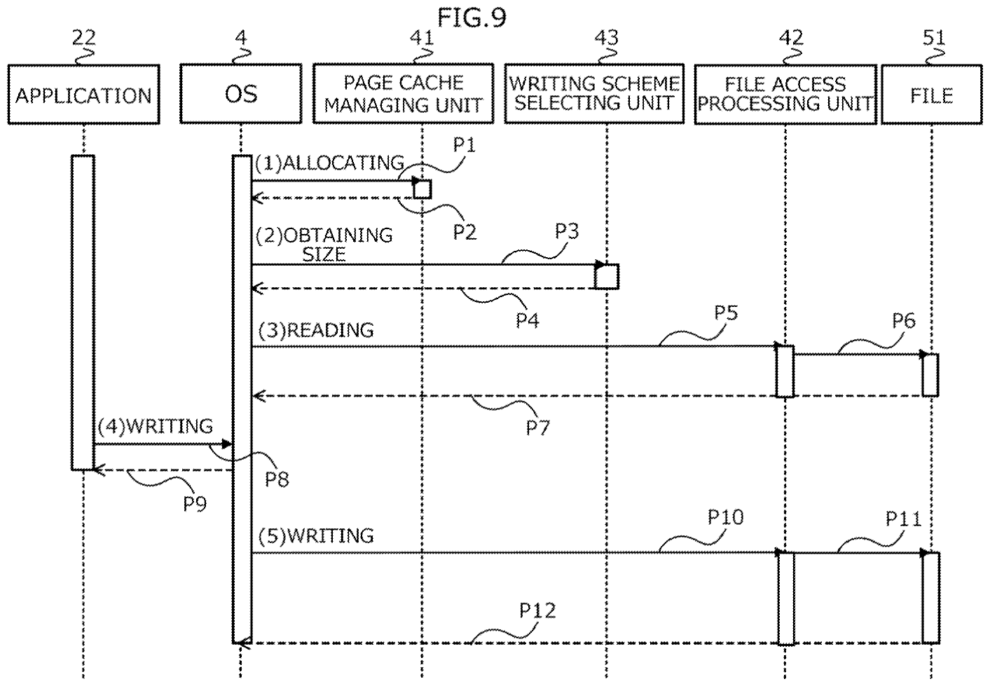

Hereinafter, description will now be made in relation to an example of operation when a writing process occurs in executing the application 22 by the OS 4 with reference to FIGS. 8 and 9.

FIG. 8 is a diagram illustrating an example of operation of a writing process in the first embodiment, and FIG. 9 is a sequence diagram illustrating an example of operation of a writing process in the first embodiment. Hereinafter, description will now be made in sequence of the processes indicated by the reference numbers (1) to (5) in FIGS. 8 and 9.

(1) As illustrated in FIG. 8, in cases where the OS 4 detects a store-instruction during the execution of the application 22 and the writing target data for the store-instruction is not present in the page cache 11, the OS 4 allocates the page cache 11 to the virtual address space 12. For example, as illustrated in FIG. 9, the OS 4 instructs the page cache managing unit 41 to allocate the page cache 11 to the virtual address space 12 and thereby obtains the mmap region 12a (processes P1 and P2). The mmap region 12a is a region in which the file 51 stored in storing unit 5 is mapped into the virtual address space 12.

Incidentally, an example of a condition to start the above-described processing (1) is a case where the data related to the store-instruction is not present in the page cache 11. For example, when the application 22 writes data that is not present in the page cache 11, a page fault occurs. In the event of occurrence of a page fault, the control is passed to the OS 4 and the address of the store-instruction that the processor 10a executes is notified to the OS 4. Accordingly, the OS 4 may start the above-described process (1) in response to the occurrence of a page fault.

As described above, in cases where the first writing process to write the first data into the mmap region 12a is detected by the OS 4, the writing scheme selecting unit 43 obtains the data size (the first data size) of the first data from the data size recording table 23.

(2) The OS 4 obtains the data size of the writing target data based on the address of the store-instruction obtained by the notification accompanied by the occurrence of the page fault by referring to the data size recording table 23. For example, the OS 4 instructs the writing scheme selecting unit 43 to obtain the data size, and obtains the data size from the data size recording table 23 (processes P3 and P4), as illustrated in FIG. 9.

For example, the writing scheme selecting unit 43 may search for an entry whose address matches that of the store-instruction by referring to the data size recording table 23, using the address of the store-instruction as the key. The writing scheme selecting unit 43 may obtain, from the entry specified by the search, the data size if the data size is a constant value, or the address or the register name of a variable value in which the data size is stored if the data size is the variable value, and respond to OS 4 with the obtained information. In cases where the obtained information is an address or a register name, the writing scheme selecting unit 43 may obtain the data size by accessing the address or the register name.

(3) The OS 4 reads the data related to the store-instruction from the file 51 into the page cache 11 in a predetermined case. An example of the predetermined case is when the obtained data size is less than a threshold exemplified by the page size. For example, the OS 4 (file access processing unit 42) reads second data corresponding to the first data from the file 51 stored in the storing unit 5 to the page cache 11. The second data may be data having a larger data size (second data size) than the data size of the first data, and may be data having a page size or more, for example, data having a page size.

As an example, the OS 4 instructs the file access processing unit 42 to read the file 51 (for example, at least partial data thereof) from the storing unit 5 to the page cache 11 and the read data is stored in the page cache 11 (processes P5 to P7), as illustrated in FIG. 9. The page cache 11 into which the data of the file 51 is written is an example of a writing region of the second data in multiple page caches 11 (or memory 10b).

When the obtained data size of the first data is equal to or larger than the threshold, the OS 4 suppresses reading of the second data from the file 51 to the page cache 11.

(4) The application 22 rewrites part of data of the second data with the first data in the page cache 11. For example, after the data is stored in the page cache 11, the application 22 executes a store-instruction that writes the writing target data into the page cache 11 mapped to the mmap region 12a (processes P8 and P9 in FIG. 9).

(5) The OS 4 writes third data obtained by the rewriting from the page cache 11 to the file 51 stored in the storing unit 5. The third data is data after the rewriting by the processing (4) described above performed on the second data, and is data having the second data size. For example, as illustrated in FIG. 9, the OS 4 instructs the file access processing unit 42 to write the writing target data to the page cache 11, for example, the second data in which the first data is written, to the storing unit 5, so that the data is written into the file 51 (processes P10 to P12 in FIG. 9).

In cases where the data related to the store-instruction is present in the page cache 11, server 1 may skip the above-described processes (1) to (3) performed by OS 4 and execute the above-described processes (4) and (5).

Further, in the process (3), in cases where the obtained data size of the first data is equal to or larger than the threshold and reading of the second data to the page cache 11 is suppressed, the application 22 and the OS 4 may execute the processes (4) and (5) in the following manner. For example, the application 22 may write the first data into the page cache 11, and the OS 4 may cause the file access processing unit 42 to write the first data from the page cache 11 to the file 51 stored in the storing unit 5. The page cache 11 into which the first data having a data size equal to or larger than the threshold is written is an example of a writing region of the first data in multiple page caches 11 (or memory 10b).

As described above, the server 1 according to the first embodiment can obtain the data size of the writing target data when the writing process occurs in the application 22 by using the data size recording table 23 corresponding to the application 22.

For example, when data as much as a page size (e.g., 4 KB) in the page cache 11 is to be rewritten in data writing into the mmap region 12a, there is no need to read the data from the file 51 to the page cache 11.

Therefore, in cases where the obtained data size is equal to or larger than the page size (4 KB), the server 1 can shorten the time taken from invoking the writing process to the completion of the writing by omitting (suppressing) reading of the data from the file 51 to the page cache 11. For example, since the reading time that occupies most of the time (e.g., 10 μs) from invoking the writing process to the completion of the writing can be omitted, the time can be shortened to, for example, about 1 μs.

As described above, the server 1 according to the first embodiment can increase the performance of the writing process into the mmap region 12a by adopting a different approach, which obtains the data size related to the writing process, different from the scheme illustrated in FIG. 4. That is, even when writing of data larger than the predetermined size or more is generated under a case where the data is not present in the page cache 11, the server 1 can accomplish the writing process by inhibiting reading the file 51 from the storing unit 5 to the page cache 11.

### [1-4] Example of Operation

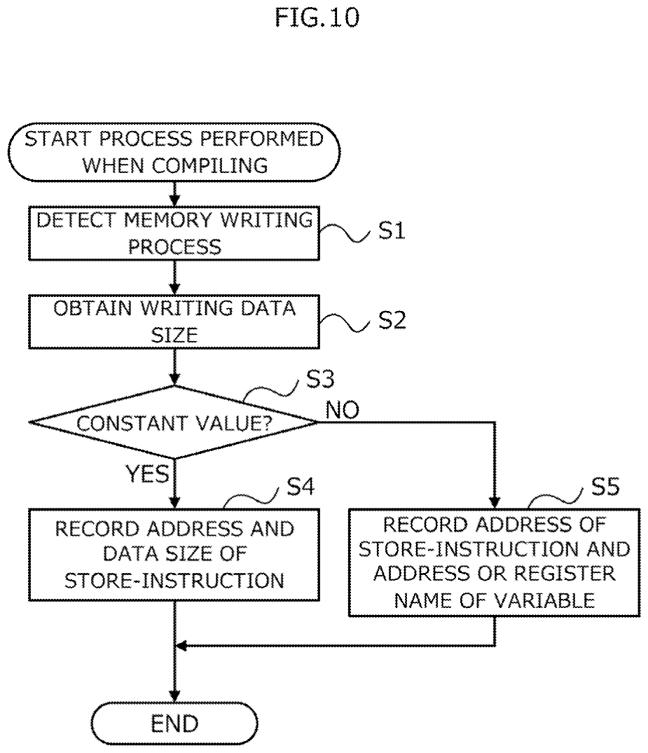

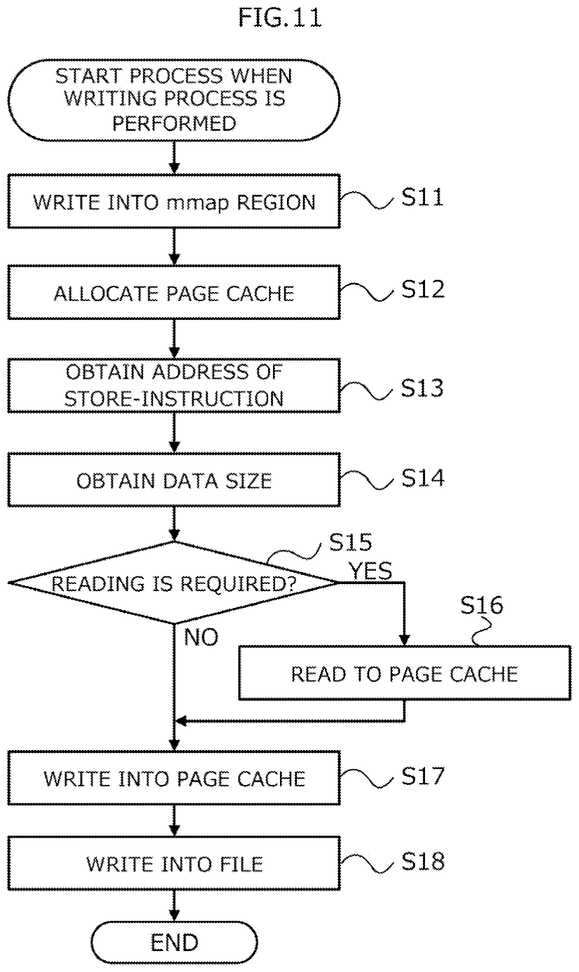

Next, description will now be made in relation to an example of operation of the server 1 according to the first embodiment configured as the above by referring to FIGS. 10 and 11. FIG. 10 is a flow diagram illustrating an example of operation when the server 1 executes compiling, and FIG. 11 is a flow diagram illustrating an example of operation when the server 1 executes a writing process.

[1-4-1] Example of Operation when Compiling:

First, description will now be made in relation to an example of operation when the server 1 executes compiling by referring to FIG. 10. As illustrated in FIG. 10, upon detection of a memory writing process (Step S1) while the compiler 3 is compiling the source code 21, the writing process detecting unit 31 obtains the data size of writing target data (Step S2).

The writing process detecting unit 31 determines whether or not the obtained data size is a constant value (Step S3). If the data size is a constant value (YES in Step S3), the writing process detecting unit 31 records an entry containing the address and the data size of a store-instruction into the data size recording table 23 (Step S4), and the process ends.

If the data size is not a constant value (is a variable value) (NO in Step S3), the writing process detecting unit 31 records an entry containing the address of the store-instruction and the address or the register name of the variable value into the data size recording table 23 (Step S5), and the process ends.

While the compiling is being carried out after the process of steps S1 to S5 is completed, the writing process detecting unit 31 may wait for detection of another memory writing process and, upon detection of a memory writing process, and carry out the process of steps S1 to S5.

[1-4-2] Example of Operation when Writing Process is Performed:

Next, description will now be made in relation to an example of operation when the server 1 executes a writing process by referring to FIG. 11. The example of FIG. 11 assumes that the application 22 writes data that is not present in the page cache 11, a page fault consequently occurs, and the control is passed to the OS 4.

As illustrated in FIG. 11, when a writing process into the mmap region 12a by the application 22 that the OS 4 is executing occurs (Step S11), the OS 4 causes the page cache managing unit 41 to allocate the page cache 11 to the virtual address space 12 (Step S12).

For example, the OS 4 obtains the address of the store-instruction based on a notification due to the page fault (Step S13).

The OS 4 causes the writing scheme selecting unit 43 to obtain the data size of the data related to the store-instruction from data size recording table 23 on the basis of the address of the store-instruction (Step S14).

The OS 4 causes the writing scheme selecting unit 43 to determine whether or not data is read from the file 51 to the page cache 11 on the basis of, for example, a comparison between the data size and the threshold (Step S15).

If the data is determined to be read (YES in Step S15), which means, for example, that the data size is less than the threshold, the OS 4 causes the file access processing unit 42 to read the data from the file 51 to the page cache 11 (Step S16), and then the process proceeds to Step S17. On the other hand, if the data is determined not to be read (NO in Step S15) which means, for example, the data size is equal to or larger than the threshold, the process proceeds to Step S17.

In Step S17, the application 22 writes the data related to the store-instruction into the page cache 11. For example, the application 22 rewrites part of the data read from file 51 with the data related to the store-instruction in the page cache 11.

The OS 4 causes the file access processing unit 42 to write the data written in the page cache 11 into the file 51 in units of a page size (Step S18), and the process ends.

### [1-5] First Modification to First Embodiment

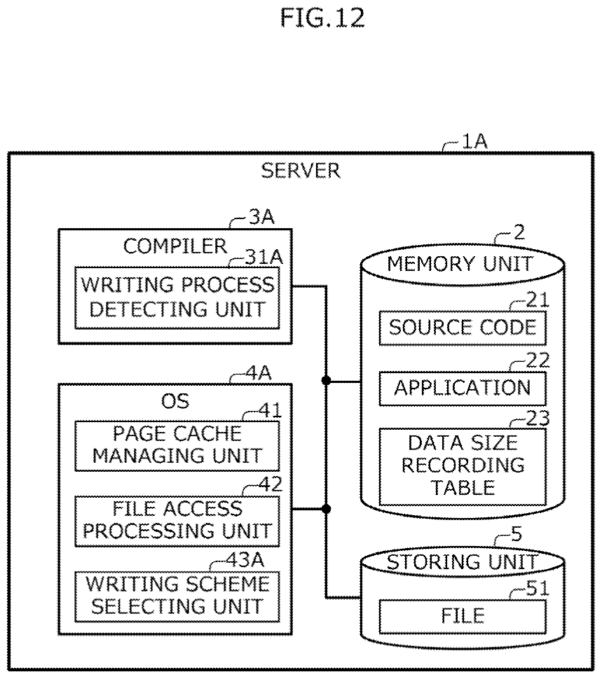

Next, description will now be made in relation to a first modification to the first embodiment. FIG. 12 is a block diagram illustrating an example of the functional configuration of a server 1A according to a first modification to the first embodiment. As illustrated in FIG. 12, the compiler 3A of the sever 1A may include a writing process detecting unit 31A different from the writing process detecting unit 31 of the first embodiment, and the OS 4A may include a writing scheme selecting unit 43A different from the writing scheme selecting unit 43 of the first embodiment.

In the following first modification, the configuration, processing, and function that are not particularly mentioned are assumed to be the same as the configuration, processing, and function of the first embodiment already described.

In addition to the process of the writing process detecting unit 31, the writing process detecting unit 31A determines the optimum writing scheme also upon detection of a memory writing process during, before, and after executing the compiling. For example, for first data having a data size having a constant value and less than the threshold and being related to a memory writing process, the writing process detecting unit 31A determines that the second data corresponding to the first data is read from the file 51 into the page cache 11 and inhibits the information of the first data from being recorded into the recording in the data size recording table 23.

In addition to the processing of the writing scheme selecting unit 43, the writing scheme selecting unit 43A carries out, in cases where the address related to the writing process is not present in the data size recording table 23 when the writing process is performed, a reading process that reads second data corresponding to the first data related to the writing process from the file 51 to the page cache 11.

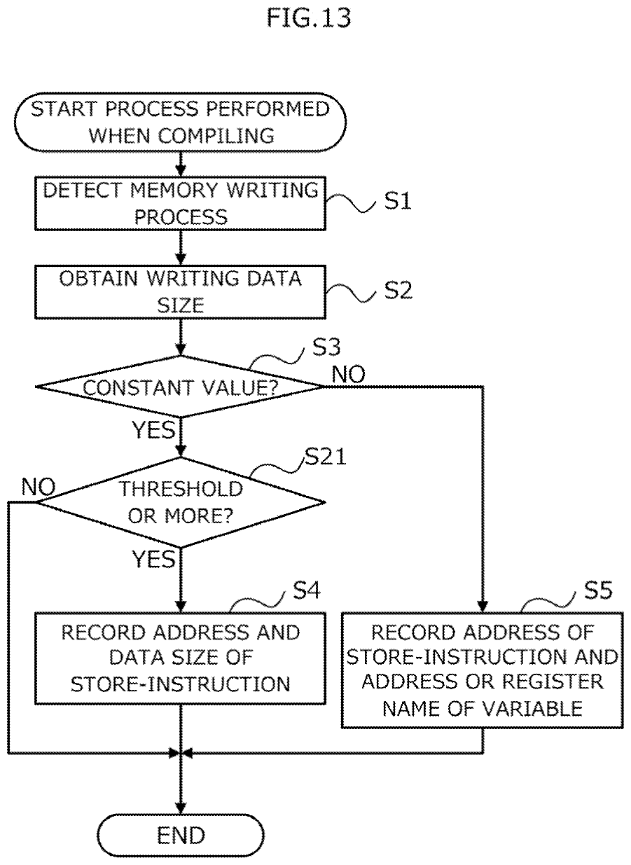

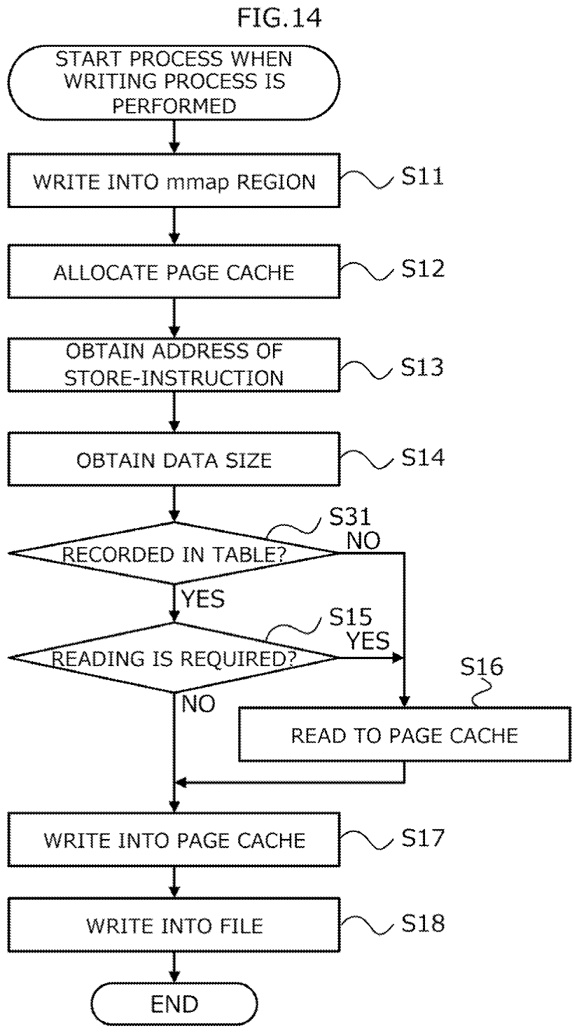

Next, description will now be made in relation to example of operation of the server 1A according to the first modification configured as described above with reference to FIGS. 13 and 14.

FIG. 13 is a flow diagram illustrating an example of operation when the server 1A executes compiling. The flow of FIG. 13 further has Step S21 between Steps S3 and S4 in addition to the flow of FIG. 10.

As illustrated in FIG. 13, in cases where the obtained data size is a constant value (YES in Step S3), the writing process detecting unit 31A determines whether or not the obtained data size is equal to or larger than the threshold (Step S21). In cases where the obtained data size is equal to or larger than the threshold (YES in Step S21), the writing process detecting unit 31A records an entry including the address and the data size of the store-instruction into the data size recording table 23 (Step S4), and the process ends.

In cases where the obtained data size is less than the threshold (NO in Step S21), since a reading process from the file 51 to the page cache 11 occurs, the writing process detecting unit 31A suppresses the recording of the data information of the data size recording table 23, and the process ends.

FIG. 14 is a flow diagram illustrating an example of operation when the server 1A executes a writing process. The flow of FIG. 14 further has Step S31 between Steps S14 and S15 in addition to the flow of FIG. 11.

As illustrated in FIG. 14, the OS 4A causes the writing scheme selecting unit 43A to determine whether or not the data size of the data related to the address of the store-instruction is present in the data size recording table 23 (Step S31). In other words, the writing scheme selecting unit 43A, in Step S14, determines whether or not the data size of the data related to the store-instruction can be obtained from the data size recording table 23.

In cases where the data size is present in the data size recording table 23 (YES in Step S31), the process proceeds to Step S15. On the other hand, if the data size is not present in the data size recording table 23 (NO in Step S31), the process proceeds to Step S16.

As described above, the server 1A according to the first modification can attain the same effect as the server 1 of the first embodiment.

Further, the server 1A can determine the optimum writing scheme in the event of detection of a memory writing process during compiling. Thus, in cases where the data size is not present in the data size recording table 23 in the execution of the writing process (i.e., the data size is not obtained), the server 1A can determine that the reading process to the page cache 11 is to be performed, so that the process of comparing the data size and the threshold can be omitted. Consequently, the processing time by the writing scheme selecting unit 43A can be shortened, so that is it possible to increase the writing performance into the mmap 12a.

### [1-6] Second Modification of First Embodiment

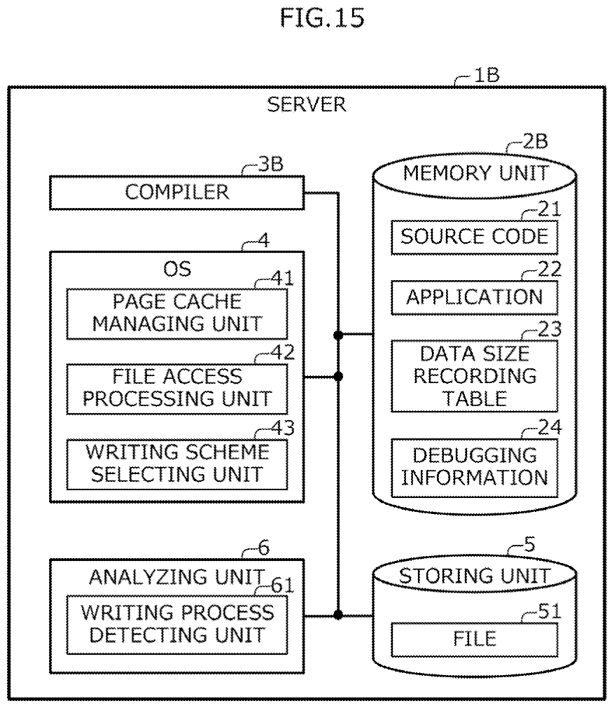

Next, description will now be made in relation to a second modification to the first embodiment. FIG. 15 is a block diagram illustrating an example of the functional configuration of a server 1B according to a second modification to the first embodiment. As illustrated in FIG. 15, the server 1B may further include an analyzing unit 6. The memory unit 2B of the server 1B may be capable of storing debugging information 24 in addition to the information stored in the first embodiment. In addition, the compiler 3B of the server 1B may omit the configuration of the writing process detecting unit 31. The function of the analyzing unit 6 may be achieved by performing the program 10g that the processor 10a of the computer 10 illustrated in FIG. 5 deploys in the memory 10b.

In the following second modification, the configuration, processing, and function that are not particularly mentioned are assumed to be the same as the configuration, processing, and function of the first embodiment already described. The example of FIG. 15 is based on the configuration of the first embodiment illustrated in FIG. 6, but is not limited thereto. Alternatively, the second modification may apply a modification of FIG. 15 to the server 1A according to the first modification illustrated in FIG. 12.

The compiler 3B may convert the source code 21 into the application 22 by compiling the source code 21, generate the debugging information 24 through compiling, and store the generated debugging information 24 into the memory unit 2B. The above-described process of the compiler 3B may be implemented by any known compiler.

The debugging information 24 is information output from the compiler 3B for the purpose of debugging during or after the compiling of the source code 21, and may include, by way of example, line information, address information, frame information, and location information.

The line information is information that associates a file name of the source code 21, the line number, and the address of the execution binary with one another. In other words, the line information is information that associates the line number of the source code 21 with the instruction address, and may be represented in the form of an association table, for example.

The address information is information that associates the file of the source code 21 to the address range of an execution file.

The frame information is the information of a stack frame in the function. The location information is the allocation information of a local variable.

The analyzing unit 6 analyzes the data size related to the writing process that the application 22 executes on the basis of the source code 21 and the debugging information 24, and may be, for example, software (application) such as an analysis tool. As illustrated in FIG. 15, the analyzing unit 6 may be provided with a writing process detecting unit 61.

The writing process detecting unit 61 generates (records), instead of the writing process detecting unit 31 of FIG. 6, the data size recording table 23 on the basis of the source code 21 and the debugging information 24.

For example, the writing process detecting unit 61 can identify a file and a line in the file in the source code 21 that are associated with a process actually performed in the application 22 on the basis of the source code 21 and the line information in the debugging information 24.

Also, in cases where a function invokes a function on the basis of the frame information, the writing process detecting unit 61 can investigate the function invoking the function to be executed (being executed) by the application 22.

Furthermore, the writing process detecting unit 61 can identify a stack region or a register that the local variation is allocated to on the basis of the location information, in other words, obtain the value of the local variable.

The OS 4 can perform processing at the time of executing a writing process in the same manner as that performed in the first embodiment or the first modification on the basis of the data size recording table 23 outputted from the analyzing unit 6.

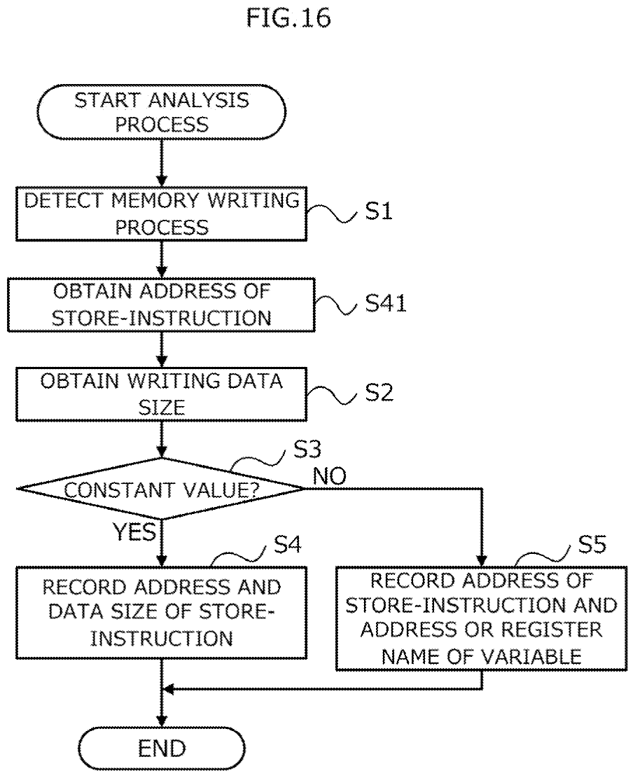

Next, description will now be made in relation to an example of operation of the server 1B according to the second modification configured as described above with reference to FIG. 16. FIG. 16 is a flow diagram illustrating an example of operation when the server 1B executes an analysis process.

The flow of FIG. 16 further has Step S41 between Steps S1 and S2 in addition to the flow of FIG. 10. The processes of Steps S1 to S5 illustrated in FIG. 10 are executed by the writing process detecting unit 31 of the compiler 3 (see FIG. 6), but the processes of Steps S1 to S5 of FIG. 16 are executed by the writing process detecting unit 61 of the analyzing unit 6.

As illustrated in FIG. 16, upon detection of a memory writing process (Step S1), the writing process detecting unit 61 obtains the address of the store-instruction from the debugging information 24 (Step S41). Then, the writing process detecting unit 61 obtains the data size of the writing target data (Step S2).

As described above, the server 1B according to the second modification can obtain the same advantages as those obtained by the server 1 according to the first embodiment, and the server 1A according to the first modification.

Further, including the analyzing unit 6 that generates the data size recording table 23 based on the source code 21 and the debugging information 24, the server 1B can use a typical compiler as the compiler 3B. Therefore, for example, the method according to the second modification can be easily applied to an existing system.

Incidentally, one or both of the compiler 3B and the analyzing unit 6 may be implemented, as part of the function of the OS 4, in the OS 4. Also, one or both of the compiler 3B and the analyzing unit 6 may be provided in a computer different from the server 1B. In cases where one or both of the compiler 3B and the analyzing unit 6 are provided in the different computer, the server 1B may include a receiving unit. The receiving unit receives one or both of the application 22 output by the compiler 3B and the data size recording table 23 output by the analyzing unit 6 from the different computer, and stores the received data into the memory unit 2B. Also, in cases where one or both of the compiler 3B and the analyzing unit 6 are provided in the different computer, the memory unit 2B may be allowed not to store the source code 21.

### [2] Second Embodiment

### [2-1] Description of Second Embodiment

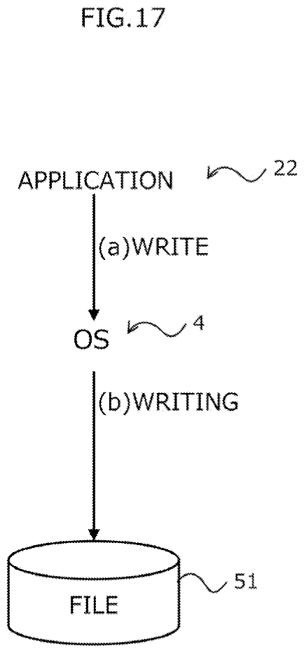

Next, the second embodiment will now be described. First, description will now be made in relation to a file writing process (direct write) performed by the OS 4. FIG. 17 is a diagram illustrating an example of operation of a file writing process (direct write) of the OS 4.

As illustrated in FIG. 17, the direct write is a process in which the OS 4 writes the file 51 (data) directly into the storing unit 5, bypassing the page cache 11. For example, when the application 22 issues a direct write system call (see reference sign (a)), the OS 4 writes the data into the file 51 (see reference sign (b)).

Direct write is suitable, for example, for writing low frequently accessed data. When low frequently accessed data is written into the page cache 11, other data is evicted from the page cache 11. If the evicted other data is high frequently accessed data, a reading process into the page cache 11 occurs when the other data is written, so that the accessibility lowers. For this reason, by writing low frequently accessed data by direct write, other data which is high frequently accessed can be placed in the page cache 11, so that the accessing performance can be enhanced.

With the foregoing in view, description of the second embodiment is made in relation to a scheme that selects the optimum writing scheme based on the access frequency to data related to a writing process in addition to the process according to the first embodiment.

### [2-2] Example of Configuration of Second Embodiment

(Example of Hardware Configuration)

The computer 10 according to the second embodiment may have the same HW configuration as the computer 10 according to the first embodiment illustrated in FIG. 5.

(Example of Functional Configuration)

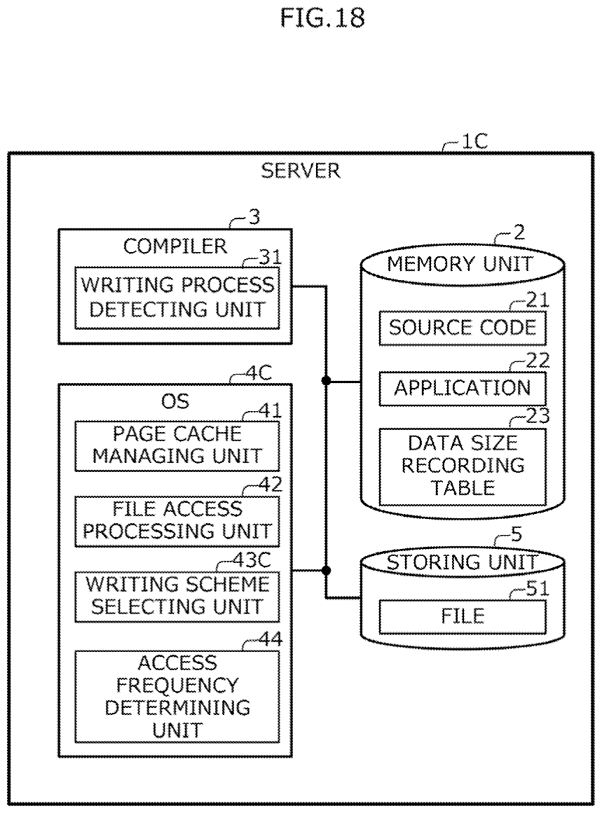

FIG. 18 is a block diagram illustrating an example of the functional configuration of a server 1C according to the second embodiment. As illustrated in FIG. 18, the OS 4C of server 1C may include a writing scheme selecting unit 43C different from writing scheme selecting unit 43 according to the first embodiment, and may further include an access frequency determining unit 44.

In the following of the second embodiment, the configuration, processing, and function that are not particularly mentioned are assumed to be the same as the configuration, processing, and function of the first embodiment, the first modification and the second modification of the first embodiment already described. The example of FIG. 18 is based on the configuration of the first embodiment illustrated in FIG. 6, but is not limited thereto. Alternatively, the second embodiment may apply a configuration of FIG. 18 to the server 1A according to the first modification illustrated in FIG. 12 or the server 1B according to the second modification illustrated in FIG. 15.

The access frequency determining unit 44 is an example of a determining unit that determines the access frequency to the first data. Access frequency determining unit 44 determines the access frequency to data related to a writing process. For example, the access frequency determining unit 44 may determine the access frequency of data related to a writing process by one or both of the following schemes (A) and (B).

(A) LFU (Least Frequency Used) Base:

For example, the access frequency determining unit 44 may record the number of times of accesses to each page in the page cache 11, and determine that the data stored in a page having a small number of times of accesses is low frequently accessed. Specifically, the access frequency determining unit 44 may determine a data stored in a page having the number of times of accesses less than a time threshold or x pages (where x is an integer of one or more) from the bottom or the top of the pages sorted according to the number of times of accesses in descending or ascending order to be the data low frequently accessed.

(B) LRU (Least Recently Used) Base:

For example, the access frequency determining unit 44 may record the access time for each page in the page cache 11, and approximately determine the data stored in a page having the farthest access time, i.e., having a large (e.g., maximum) difference between the recorded access time and the current time to be the data low frequently accessed.

An LRU-based algorithm is used in various types of OS. For the purpose of speeding up, the LRU-based algorithm approximately determines an access frequency on the basis of whether or not the page is accessed recently.

Thereby, the access frequency determining unit 44 can perform the determination in the scheme (B) faster than the scheme (A). The second embodiment assumes that the access frequency determining unit 44 adopts the above scheme (B) to determine the access frequency.

For example, the access frequency determining unit 44 attaches, to each page, a reference flag indicating whether or not the page has been accessed, and sets the reference flag to ON when the page is accessed. Then, the access frequency determining unit 44 periodically checks the reference flag of each page and may release a page whose flag is not ON (is OFF). In the event of releasing of a page, the access frequency determining unit 44 may export the contents of the page to the storing unit 5. In periodic checking, the access frequency determining unit 44 may set the flag being set to ON to OFF.

The access frequency determining unit 44 may execute the above-described scheme of determining the access frequency in cooperation with some functions of the OS 4C, for example, with the page cache managing unit 41.

The determination of an access frequency may also be accomplished by one or more of the OS 4C, the application 22, and the user.

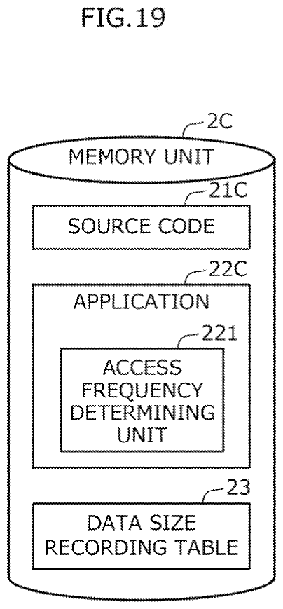

FIG. 19 is a block diagram illustrating an example of the configuration of a memory unit 2C. For example, in cases where determination of an access frequency is carried out by the application 22 or the user, the server 1C may include a memory unit 2C in place of the memory unit 2, as illustrated in FIG. 19. The memory unit 2C may be provided with a source code 21C and an application 22C in place of the source code 21 and the application 22, respectively. In this instance, the OS 4C may be allowed to have a configuration not including the access frequency determining unit 44.

The application 22C may include an access frequency determining unit 221. The source code 21C may be updated from the source code 21 (see FIG. 6), for example, such that the application 22C includes the access frequency determining unit 221.

The access frequency determining unit 221 may determine the access frequency for each data based on accesses that its own application 22C makes to the page cache 11. As an example, if the application 22C is one that manages a database, the application 22C may sometime further have a function to distinguish whether or not data is frequently used. In this case, the function may be used as the access frequency determining unit 221.

In order to notify the OS 4C of the result of determining an access frequency, the application 22C or the user may, for example, issue a writing API that explicitly uses direct write or may implicitly notify the OS 4C of the hint by specifying the address range or the like.

The following description assumes that the writing scheme selecting unit 43C uses the result of the determination made by the access frequency determining unit 44, but may alternatively use the result of determination made by at least one of the application 22C (access frequency determining unit 221) and the user.

The writing scheme selecting unit 43C selects the optimum writing scheme based on the result of the determination made by the access frequency determining unit 44. For example, in cases where the access frequency to the data related to the writing process is low, for example, less than a given frequency threshold (second threshold), the writing scheme selecting unit 43C suppresses the use of the page cache 11 and writes data into the file 51 through a writing process that does not pass through (does bypass) the page cache 11. An example of the writing process that does not pass through the page cache 11 includes, but is not limited to, the above-described direct write. The given frequency threshold may be set according to, for example, the above schemes (A) and (B).

On the other hand, in cases where the access frequency is high, which is exemplified by a case where the access frequency is equal to or larger than the given frequency threshold, the writing scheme selecting unit 43C may select the optimum writing scheme based on the data size like in the first embodiment and the first and second modifications to the first embodiment.

As the above, in cases where the access frequency to the first data is equal to or higher than the second threshold and also the data size of the first data is less than the first threshold, the OS 4C (the writing scheme selecting unit 43C and the file access processing unit 42) reads the second data from the file 51 stored in the storing unit 5 to the page cache 11. Meanwhile, in cases where the access frequency of the first data is less than the second threshold, the OS 4C suppresses reading of the second data from the file 51 to the page cache 11.

Further, when suppressing the reading of the second data, the OS 4C (file access processing unit 42) writes the first data into the file 51 stored in the storing unit 5, bypassing the page cache 11.

As described above, the server IC according to the second embodiment can obtain the same advantages as those obtained by the server 1 according to the first embodiment, the server 1A according to the first modification, and, the server 1B according to the second modification.

Further, in the event of writing low frequently accessed data, the server IC can enhance the writing performance several times by performing the writing process that bypasses the page cache 11 as compared with a case where data is written in response to a store-instruction.

### [2-3] Example of Operation

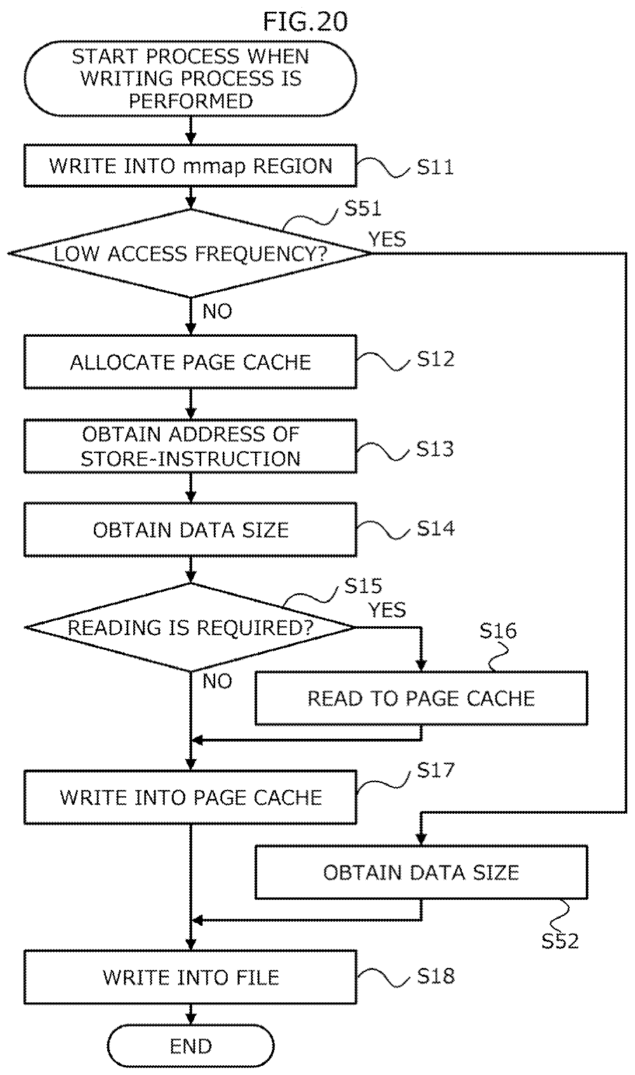

Next, description will now be made in relation to an example of operation of the server 1C of the second embodiment configured as the above by referring to FIG. 20. Here, an example of the operation when the compiling is carried out by the compiler 3 is the same as the first embodiment, the first modification, or the second modification.

FIG. 20 is a flow diagram illustrating an example of operation when the server 1C executes a writing process. The flow of FIG. 20 further has Step S51 between Steps S11 and S12 and also Step S52 between YES of Step S51 and Step S18 in addition to the flow of FIG. 11.

As illustrated in FIG. 20, the access frequency determining unit 44 determines whether or not the access frequency to the data related to store-instruction is low, for example, less than the frequency threshold (Step SS1), and notifies the result the determination to the writing scheme selecting unit 43C.

In cases where the access frequency is not low, for example, equal to or more than the frequency threshold (NO in Step S51), the process proceeds to Step S12.

In cases where the access frequency is low, for example, less than the frequency threshold (YES in Step S51), the writing scheme selecting unit 43C obtains the data size of the data related to the store-instruction from the data size recording table 23 (Step S52), and the process proceeds to Step S18. That is, in this case, the writing scheme selecting unit 43C writes the data into the file 51 through a writing process such as a direct write that does not pass through the page cache 11 (Step S18).

In cases where the writing target data into the mmap region 12a is present in the page cache 11, which means that the OS 4C has determined that the access frequency to the data is high, the writing according to the store-instruction may be performed in the same manner as in the first embodiment, the first modification, and the second modification.

### [2-4] First Modification of Second Embodiment

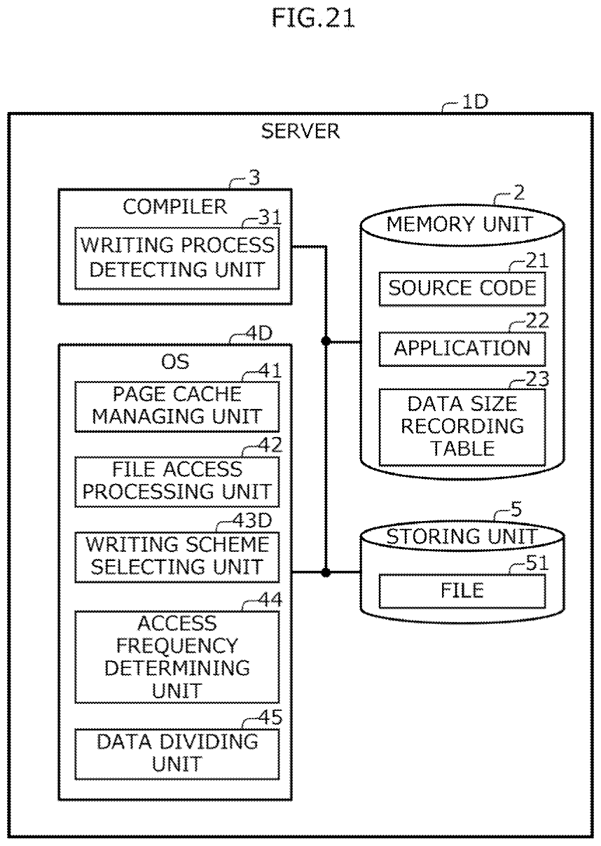

Next, a first modification to the second embodiment will now be described. FIG. 21 is a block diagram illustrating an example of the functional configuration of a server 1D according to a first modification to the second embodiment. As illustrated in FIG. 21, an OS 4D of the server 1D may include a writing scheme selecting unit 43D different from the writing scheme selecting unit 43C according to the second embodiment. The OS 4D may further include a data dividing unit 45.

In the following first modification, the configuration, processing, and function that are not particularly mentioned are assumed to be the same as the configuration, processing, and function of the second embodiment already described.

Here, the data related to the writing process (e.g., store-instruction) into the mmap region 12a by the application 22 may be a mixture containing high frequently accessed data and low frequently accessed data. An example of the writing process is key-value store (KVS) related to data store.

The KVS has a tendency that the access frequency to a key is high and the access frequency to a value is low. Therefore, the application 22 may cause simultaneous writing of a key and a value, in other words, simultaneous writing of high frequently accessed data and low frequently accessed data.

Therefore, on the basis of the result of the determination made by the access frequency determining unit 44, the data dividing unit 45 divides the data related to the writing process into the data having a low access frequency and the data not having a low access frequency (for example, the data having a high access frequency). Thus, the data dividing unit 45 is an example of a dividing unit that divides the first data into a plurality of divided data according to the access frequencies.

The writing scheme selecting unit 43D selects a writing process that does not pass through the page cache 11, for example, a direct write, as scheme of writing the low frequently accessed data among the data divided by the data dividing unit 45. On the other hand, the writing scheme selecting unit 43D selects the scheme of writing data having a high access frequency among the data divided by data dividing unit 45 on the basis of the data size in the same manner as the writing scheme selecting unit 43C according to the second embodiment.

Thus, in cases where each of the multiple divided data has an access frequency equal to or larger than the second threshold and a data size less than the first threshold, the OS 4D reads the data associated with the divided data from the file 51 stored in the storing unit 5 into the page cache 11.

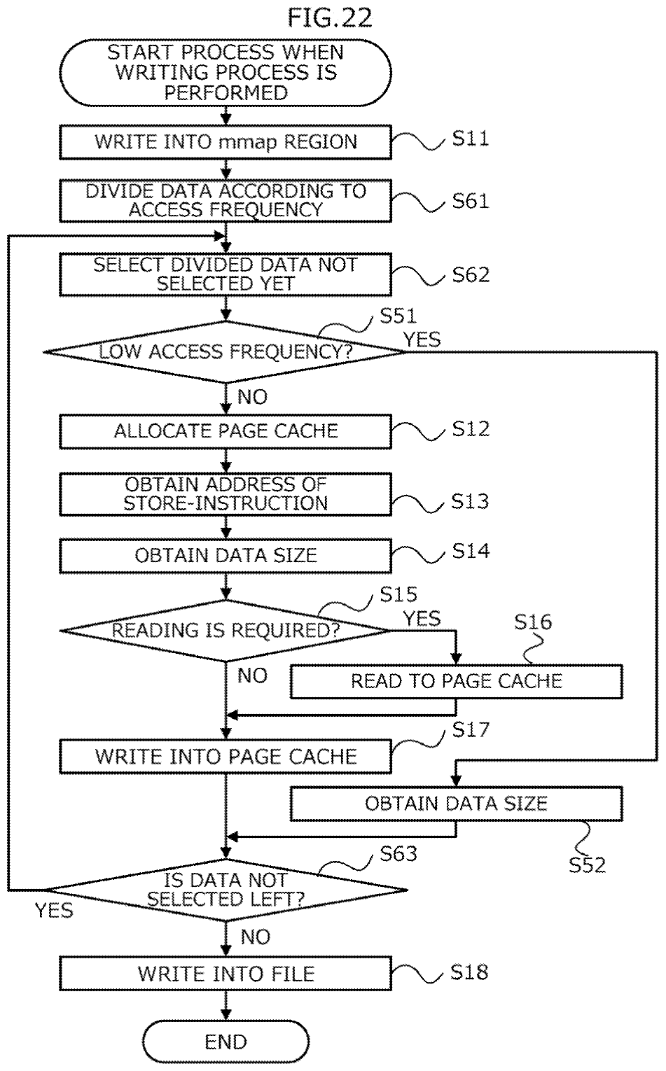

Next, description will now be made in relation to an example of operation of the server 1D according to first modification of the second embodiment configured as the above with reference to FIG. 22. The operation performed by the compiler 3 when compiling is the same as that performed in the second embodiment.

FIG. 22 is a flow diagram illustrating an example of operation when the server 1D executes a writing process. The flow of FIG. 22 further has Steps S61 and S62 between Steps S11 and S51 and also Step S63 between Steps S17 and S18 and also between Steps S52 and S18 of FIG. 20 in addition to the flow of FIG. 20.

As illustrated in FIG. 22, the data dividing unit 45 divides data related to the store-instruction on the basis of the result of the determination made by the access frequency determining unit 44, for example, on the basis of whether or not the access frequency is less than the frequency threshold (Step S61). The OS 4D causes the writing scheme selecting unit 43D to select divided data that is not selected yet (Step S62), and makes the determination of Step S51 in units of the divided data.

After the completion of Step S17 or S62, the OS 4D causes writing scheme selecting unit 43D to determine whether or not divided data not selected yet is left (Step S63), and if divided data not selected yet is left (YES in Step S63), the process proceeds to Step S62.

On the other hand, in cases where divided data not selected yet is not left (NO in Step S63), the OS 4D causes the file access processing unit 42 to write the respective divided data into the file 51, passing through or bypassing the page cache 11 (Step S18), and the process ends.

Incidentally, the process of Step S63 may be executed after Step S18.

As described above, the server 1D according to the first modification of the second embodiment can attain the same effects as the server 1C of the second embodiment.

Further, according to the server 1D, it is possible to select the data writing scheme related to a store-instruction based on the access frequency and the data size in units of divided data, in other words, with finer granularity, and to speed up access.

### [2-5] Second Modification to Second Embodiment

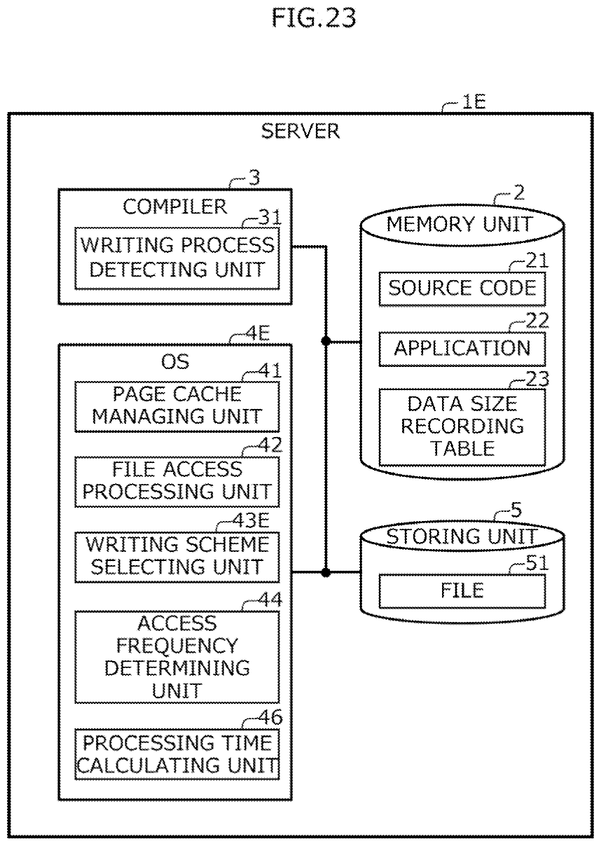

Next, a second modification to the second embodiment will now be described. FIG. 23 is a block diagram illustrating an example of the functional configuration of a server 1E according to the second modification to the second embodiment. As illustrated in FIG. 23, an OS 4E of the server 1E may include a writing scheme selecting unit 43E different from the writing scheme selecting unit 43C according to the second embodiment. The OS 4E may further include a processing time calculating unit 46.

In the following second modification, the configuration, processing, and function that are not particularly mentioned are assumed to be the same as the configuration, processing, and function of the second embodiment and the first modification to the second embodiment already described.

Here, a writing process adopting direct write takes a long processing time in some cases. For example, since direct write generates writing into a dirty page in the page cache 11, an extra time proportional to the number of dirty pages may be taken. A dirty page is a page that has been written into the page cache 11 but has not been reflected in the storing unit 5 (for example, the storing device 10c).

Since direct write make another writing into the target file 51 for the direct write wait, the throughput of the entire system may be degraded if the processing time of the direct write is prolonged.

To avoid this, the processing time calculating unit 46 calculates the processing time of the direct write. As an example, the processing time calculating unit 46 may calculate the processing time according to the following equation (1) and notify the calculated processing time to the writing scheme selecting unit 43E.

(Processing time)=(number of dirty pages included in the writing target data)×(writing time per page)+(overhead of direct write) (1)

As the above, the processing time calculating unit 46 is an example of an estimating unit that estimates processing time that the file access processing unit 42 takes to write data, bypassing the page cache 11.

In cases where the calculated processing time (estimated value) exceeds a time threshold (third threshold), the writing scheme selecting unit 43E suppresses direct write even when the access frequency is low, and selects the writing scheme on the basis of the data size.

In cases where the access frequency of the first data is less than the second threshold and also the processing time of the first data estimated by the processing time calculating unit 46 is equal to or less than the third threshold, the OS 4E suppresses reading of the second data from the file 51 to the page cache 11.

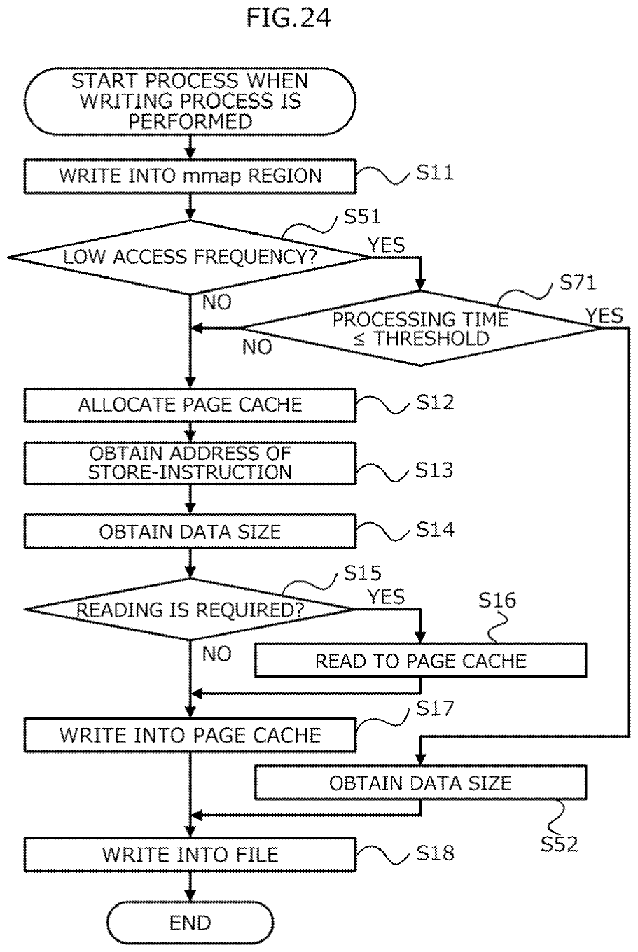

Next, description will now be made in relation to an example of operation of the server 1E according to second modification of the second embodiment configured as the above with reference to FIG. 24. The operation performed by the compiler 3 when compiling is the same as that performed in the second embodiment.

FIG. 24 is a flow diagram illustrating an example of operation when the server 1E executes a writing process. The flow of FIG. 24 further has Step S71 between Steps S51 and S52 in addition to the flow of FIG. 20.

As illustrated in FIG. 24, in cases where the access frequency to the data related to a store-instruction is low (YES in Step S51), the processing time calculating unit 46 calculates the processing time that the executing of direct write of the data into the file 51 takes.

The writing scheme selecting unit 43E determines whether or not the processing time calculated by the processing time calculating unit 46 is equal to or less than a given time threshold (Step S71).

In cases where the processing time is equal to or less than the given time threshold (YES in Step S71), the process proceeds to Step S52, and the writing scheme selecting unit 43E executes direct write on the data.

On the other hand, in cases where the processing time exceeds the given time threshold (NO in Step S71), the process proceeds to Step S12. Specifically, in this case, the writing scheme selecting unit 43E suppresses the execution of the direct write and performs a writing process based on the data size using the page cache 11.

As described above, the server 1E according to the second modification of the second embodiment can obtain the same advantages as those obtained by the server 1C according to the second embodiment, and the server 1D according to the first modification to the second embodiment.

Further, since the server 1E estimates the processing time for the direct write and suppresses execution of the direct write when the processing time is estimated to be long, it is possible to suppress the degrading the throughput of the entire system due to writing of the dirty pages.

### [3] Miscellaneous

The foregoing first embodiment, the second embodiment, and modifications thereof can be changed and modified as follows.

For example, the functional blocks of each of the servers 1 and 1A-1E of FIGS. 6, 12, 15, 18, 21, and 23 may be merged in any combination, or may be divided respectively.

In addition, each of the servers 1 and 1A-1E may be configured to achieve the respective process functions by multiple devices cooperating with each other through a network. For example, the multiple functions of each of the servers 1 and 1A-1E may be distributed to various servers such as a Web server, an application server, or a DB server. In this case, the functions of each of the servers 1 and 1A-1E may be achieved by cooperating the Web server, the application server, and the DB server with one another via a network.

In one aspect, it is possible to enhance the access performance to a storing region in which a file of a storing unit is mapped.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An information processing apparatus comprising:
a memory; and
a processor coupled to the memory, the processor being configured to:
obtain, when an operating system detects a first writing process writing first data into a region in a process space in which region a file stored in a storage is mapped, a first data size of the first data from recording information recording a data size of writing target data for a target address for each of a plurality of writing processes, the first writing process being one of the plurality of writing processes that an application executes;
read, when the first data size is less than a first threshold, a second data corresponding to the first data and having a second data size larger than the first data size from the file stored in the storage into the memory;
rewrite part of the second data stored in a writing region of the second data in the memory with the first data; and
write third data in the writing region in the memory into the file stored in the storage, the third data being a result of rewriting the part of the second data with the first data.

2. The information processing apparatus according to claim 1, wherein the processor is further configured to:
when the first data size is equal to or more than the first threshold,
suppress reading of the second data from the file into the memory;
write the first data into the memory; and
write the first data from a writing region of the first data in the memory into the file stored in the storage.

3. The information processing apparatus according to claim 1, wherein the recording information is generated, being based on information obtained in compiling that converts a source code of the application into the application.

4. The information processing apparatus according to claim 3, wherein the processor is further configured to:
generate the recording information by associating the target address with the writing target data of the writing process for each of the plurality of writing processes, the plurality of writing processes being contained in the source code.

5. The information processing apparatus according to claim 4, wherein the processor generates the recording information by a process of a complier that executes the compiling.

6. The information processing apparatus according to claim 4, wherein the processor generates the recording information based on debugging information outputted by a complier that executes the compiling.

7. The information processing apparatus according to claim 1, wherein the first threshold is a page size of the memory.

8. The information processing apparatus according to claim 1, wherein the processor is further configured to:
determine an access frequency to the first data;
read, when the access frequency to the first data is equal to or more than a second threshold and the first data size is less than the first threshold, the second data from the file stored in the storage into the memory.

9. The information processing apparatus according to claim 8, wherein the processor is further configured to:
when the access frequency to the first data is leas than a second threshold,
suppress reading of the second data from the file into the memory; and
write the first data into the file stored in the storage, bypassing the memory.

10. The information processing apparatus according to claim 9, wherein the processor is further configured to:
estimate processing time that the writing of the first data bypassing the memory takes;
suppress, when the access frequency to the first data is less than the second threshold and the processing time is equal to or less than a third threshold, reading of the second data from the file into the memory; and
write the first data into the file stored in the storage, bypassing the memory.

11. The information processing apparatus according to claim 8, wherein the processor is further configured to:
divide the first data into a plurality of divided data according to the access frequency;
read, for each of the plurality of divided data, when the divided data has an access frequency equal to or more than the second threshold and has a data size less than the first threshold, data corresponding to the divided data from the file stored into the storing unit.

12. A non-transitory computer-readable recording medium having stored therein a control program for causing a computer to execute a process comprising:
obtaining, when an operating system detects a first writing process writing first data into a region in a process space in which region a file stored in a storage is mapped, a first data size of the first data from recording information recording a data size of writing target data for a target address for each of a plurality of writing processes, the first writing process being one of the plurality of writing processes that an application executes;
reading, when the first data size is less than a first threshold, a second data corresponding to the first data and having a second data size larger than the first data size from the file stored in the storage into a memory; and
rewriting part of the second data stored in a writing region of the second data in the memory with the first data; and
writing third data in the writing region in the memory into the file stored in the storage, the third data being a result of rewriting the part of the second data with the first data.

13. The non-transitory computer-readable recording medium according to claim 12, the process further comprising:
when the first data size is equal to or more than the first threshold,
suppressing reading of the second data from the file into the memory;
writing the first data into the memory; and
writing the first data from a writing region of the first data in the memory into the file stored in the storage.

14. The non-transitory computer-readable recording medium according to claim 12, wherein the recording information is generated, being based on information obtained in compiling that converts a source code of the application into the application.

15. The non-transitory computer-readable recording medium according to claim 14, wherein the process further comprises:
generating the recording information by associating the target address with the writing target data of the writing process for each of the plurality of writing processes, the plurality of writing processes being contained in the source code.

16. The non-transitory computer-readable recording medium according to claim 15, wherein the generating includes generating the recording information by a process of a compiler that executes the compiling.

17. The non-transitory computer-readable recording medium according to claim 15, wherein the generating includes generating the recording information based on debugging information outputted by a complier that executes the compiling.

18. The non-transitory computer-readable recording medium according to claim 12, wherein the first threshold is a page size of the memory.

19. The non-transitory computer-readable recording medium according to claim 12, the process further comprising:
determining an access frequency to the first data;
reading, when the access frequency to the first data is equal to or more than a second threshold and the first data size is less than the first threshold, the second data from the file stored in the storage into the memory.

20. The non-transitory computer-readable recording medium according to claim 19, wherein the processor is further configured to:
when the access frequency to the first data is less than a second threshold,
suppressing reading of the second data from the file into the memory; and
writing the first data into the file stored in the storage, bypassing the memory.
